(19) United States
(12) Patent Application Publication
(10) Pub. No.: US 2025/0264222 A1
(43) Pub. Date: Aug. 21, 2025

(54) ADJUSTING A COOKING CYCLE ACCORDING TO THERMAL ATTRIBUTES OF COOKWARE ITEMS

(71) Applicant: Haier US Appliance Solutions, Inc., Wilmington, DE (US)

(72) Inventor: Omar Santana, Louisville, KY (US)

(21) Appl. No.: 18/442,771

(22) Filed: Feb. 15, 2024

(51) Int. Cl. F24C 7/08; H05B 1/02

(52) U.S. Cl. CPC F24C 7/083; H05B 1/0266; H05B 2213/07

(57) ABSTRACT

A method of operating a cooking appliance including at least one heating element and a temperature sensor includes determining a temperature setpoint for a cookware item; determining a power level for the at least one heating element based on the determined temperature setpoint; directing the at least one heating element over a thermal analysis phase according to the determined power level; determining a temperature rate of change at the temperature sensor at a conclusion of the thermal analysis phase; determining a material type of the cookware item based on the temperature rate of change; determining a sensor temperature target for a cooking phase following the thermal analysis phase, the sensor temperature target being based on the determined material type of the cookware item; and directing the at least one heating element according to the determined sensor temperature target for a duration of the cooking phase.

### FIELD OF THE INVENTION

The present subject matter relates generally to cooking appliances, and more particularly to methods of operating cooking appliances according to thermal behaviors of cookware items.

### BACKGROUND OF THE INVENTION

Cooking appliances generally have one or more heating elements configured for heating a cookware item. The cookware item, e.g., a pot or a pan, may be positioned on or near the one or more heating elements and food products (including, e.g., food solids, liquid, or water) may be placed inside the cookware item for cooking. A controller may selectively energize the heating element(s) to provide thermal energy to the cookware item and the food products placed therein. Alternatively, certain cooking appliances, often referred to as induction cooktops, provide energy in the form of an alternating magnetic field which causes the cookware item to generate heat. In both types of appliances, a controller selectively energizes either the heating element(s) or a magnetic coil to heat the food products until they are properly cooked.

Cookware items may exhibit different thermal properties or behaviors. For instance, some cookware items may have slower heat transfer rates, retain heat more easily, or dissipate heat more easily. For cooking appliances that are capable of performing feedback controlled heating operations, one or more algorithms may be used to incorporate certain feedback information (e.g., temperature change, temperature rate of change, etc.) over a heating period to intelligently control a power level of the heating element(s). However, when cookware items exhibit different properties, an offset difference between an actual temperature of the cookware item and an observed temperature at the temperature sensor results in undesirable heating behaviors, such as excessive temperature overshoots, an increased steady-state maintained temperature, and the like.

Accordingly, a cooking appliance and method of operating a cooking appliance that obviates one or more of the above-mentioned drawbacks would be desirable. In particular, a cooking appliance capable of adjusting a temperature target of a heating operation based on properties of the cookware item would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include at least one heating element to selectively supply heat to a cookware item; a temperature sensor configured to selectively monitor a temperature of the cookware item; and a controller operably connected with the at least one heating element and the temperature sensor, the controller configured to perform a heating operation. The heating operation may include determining a temperature setpoint; determining a power level for the at least one heating element based on the determined temperature setpoint; directing the at least one heating element over a thermal analysis phase according to the determined power level; determining a temperature rate of change at the temperature sensor at a conclusion of the thermal analysis phase; determining a material type of the cookware item based on the temperature rate of change; determine a sensor temperature target for a cooking phase following the thermal analysis phase, the sensor temperature target being based on the determined material type of the cookware item, and directing the at least one heating element according to the determined sensor temperature target for a duration of the cooking phase.

In another exemplary aspect of the present disclosure, a method of operating a cooking appliance is provided. The cooking appliance may include at least one heating element and a temperature sensor. The method may include determining a temperature setpoint for a cookware item; determining a power level for the at least one heating element based on the determined temperature setpoint; directing the at least one heating element over a thermal analysis phase according to the determined power level; determining a temperature rate of change at the temperature sensor at a conclusion of the thermal analysis phase; determining a material type of the cookware item based on the temperature rate of change; determine a sensor temperature target for a cooking phase following the thermal analysis phase, the sensor temperature target being based on the determined material type of the cookware item, and directing the at least one heating element according to the determined sensor temperature target for a duration of the cooking phase.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven range according to exemplary embodiments of the present disclosure.

FIG. 2 provides a side cut-away view of the exemplary oven range of FIG. 1.

FIG. 3 provides a graph illustrating a comparison of cookware temperatures and sensor temperatures over time according to exemplary embodiments of the present disclosure.

FIG. 4 provides a graph illustrating a comparison of a cookware item temperature against a cookware setpoint and a sensor temperature against a sensor target according to exemplary embodiments of the present disclosure.

FIG. 5 provides a graph illustrating multiple sensor temperatures over a thermal analysis phase of an exemplary heating operation.

FIG. 6 provides a graph illustrating multiple temperature rates of change of different cookware items at different setpoints of exemplary heating operations.

FIG. 7 provides a table illustrating a plurality of threshold temperature rates of change for a plurality of temperature setpoints according to exemplary embodiments of the present disclosure.

FIG. 8 provides a table illustrating a plurality of coefficient values for a plurality of cookware item materials according to exemplary embodiments of the present disclosure.

FIG. 9 provides a table illustrating a plurality of coefficient values for a plurality of temperature setpoints and cookware item materials according to exemplary embodiments of the present disclosure.

FIG. 10 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

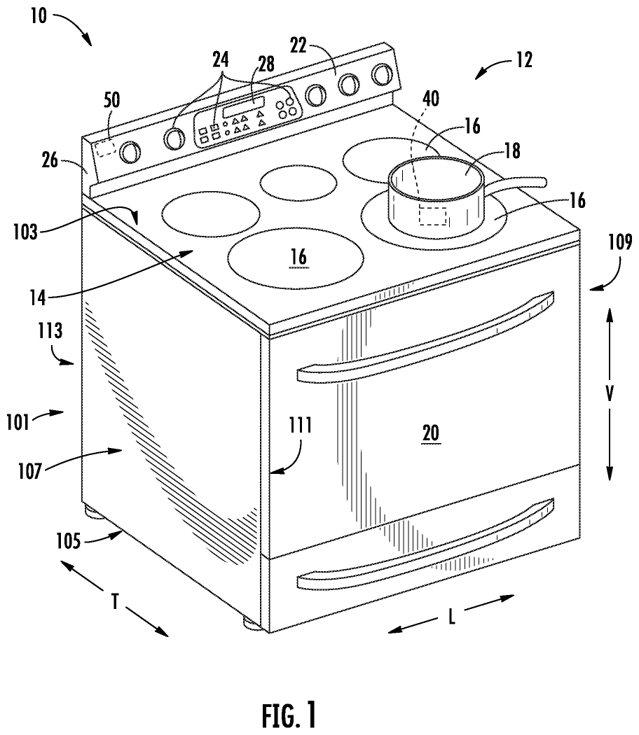

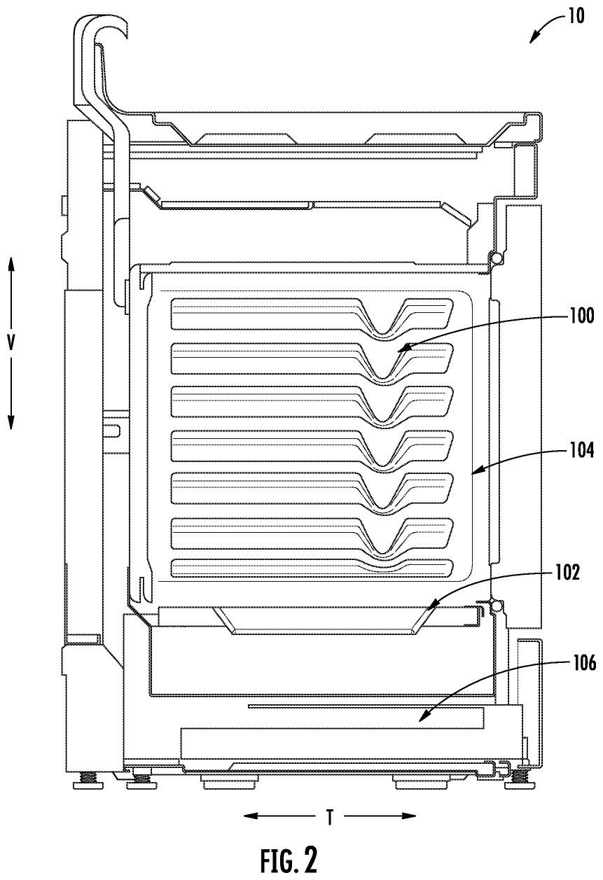

FIG. 1 provides a perspective view of a cooking appliance, or oven range 10, including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range 10 and/or cooktop 12 configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. For the embodiment depicted, cooktop 12 includes five heating elements 16 spaced along cooking surface 14. Heating elements 16 may be electric heating elements and are positioned at, e.g., on or proximate to, the cooking surface 14. In certain exemplary embodiments, cooktop 12 is a radiant cooktop with resistive heating elements or coils mounted below cooking surface 14. However, in other embodiments, the cooktop appliance 12 includes other suitable shape, configuration, and/or number of heating elements 16, for example, cooktop 12 may be an open coil cooktop with heating elements 16 positioned on or above surface 14. Additionally or alternatively, in other embodiments, cooktop 12 may include any other suitable type of heating element 16, such as an induction heating element. Each of the heating elements 16 may be the same type of heating element 16, or cooktop 12 may include a combination of different types of heating elements 16.

As mentioned, heating element 16 may be an induction style heating element. Thus, as would be understood by those skilled in the art, appliance 10 may supply a current to heating element 16 (e.g., such as a Lenz coil). As such, current may pass through heating element 16 to generate a magnetic field. The magnetic field may be a high frequency circulating magnetic field. The magnetic field may be directed towards and through cooktop appliance 12 to a cookware item (e.g., cookware item 18, described below). In particular, when the magnetic field penetrates cookware item 18, the magnetic field induces a circulating electrical current within cookware item 18. The material properties of cookware item 18 may restrict a flow of the induced electrical current and convert the induced electrical current into heat within cookware item 18. As cookware item 18 heats up, contents of cookware item 18 contained therein heat up as well. In such a manner, the induction heating element can cook the contents of cookware item 18.

As shown in FIG. 1, a cooking utensil (or cookware item) 18, such as a pot, pan, or the like, may be placed on a heating element 16 to heat cookware item 18 and cook or heat food items placed within cookware item 18. Cooking appliance 10 may also include a door 20 that permits access to a cooking chamber 104 of oven range 10, e.g., for cooking or baking of food items therein. A control panel 22 having controls 24 may permit a user to make selections for cooking of food items. Although shown on a backsplash or back panel 26 of oven range 10, control panel 22 may be positioned in any suitable location.

Controls 24 may include buttons, knobs, and the like, as well as combinations thereof, and/or controls 24 may be implemented on a remote user interface device such as a smartphone. As an example, a user may manipulate one or more controls 24 to select a temperature and/or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or inputs from a user regarding the cooking operation. Display 28 may be any suitable display capable of providing visual feedback, such as a liquid crystal display (LCD), a light emitting diode (LED) display, a segmented display, or the like. Additionally or alternatively, display 28 may be a touch display capable of receiving touch inputs from a user.

Cooktop appliance 12 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware.

Additionally, or alternatively, the instructions can be executed logically and/or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases and/or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Cooking appliance 10 may include a temperature sensor 40. Temperature sensor 40 may be configured to selectively sense a temperature of a cookware item (e.g., cookware item 18) as it is heated. For instance, temperature sensor 40 may be integrally formed with cooking appliance 10 (e.g., within cooktop 12, within cooking chamber 104, etc.). In some embodiments, temperature sensor 40 is operably connected to cooking appliance 10 (e.g., via a port or socket, via a remote connection, etc.). For one example, temperature sensor 40 is provided within cookware item 18 and operably connected to controller 50 during a cooking operation. Temperature sensor 40 may monitor a temperature of cookware item 18 or a food item provided within cookware item 18. Accordingly, temperature sensor 40 may deliver signals (e.g., voltage signals) representing the temperature of cookware item 18 to controller 50. The signals may be sent according to a predetermined frequency (e.g., at predetermined time intervals). Thus, controller 50 may analyze a temperature or temperature change of cookware item 18.

As used herein, “temperature sensor” or the equivalent is intended to refer to any suitable type of temperature measuring system or device positioned at any suitable location for measuring the desired temperature. Thus, for example, temperature sensor 40 may be any suitable type of temperature sensor, such as a thermistor, a thermocouple, a resistance temperature detector, a semiconductor-based integrated circuit temperature sensor, etc. In addition, temperature sensor 40 may be positioned at any suitable location and may output a signal, such as a voltage, to a controller that is proportional to or indicative of the temperature being measured. Although exemplary positioning of temperature sensors is described herein, it should be appreciated that appliance 10 may include any other suitable number, type, and position of temperature or other sensors according to alternative embodiments.

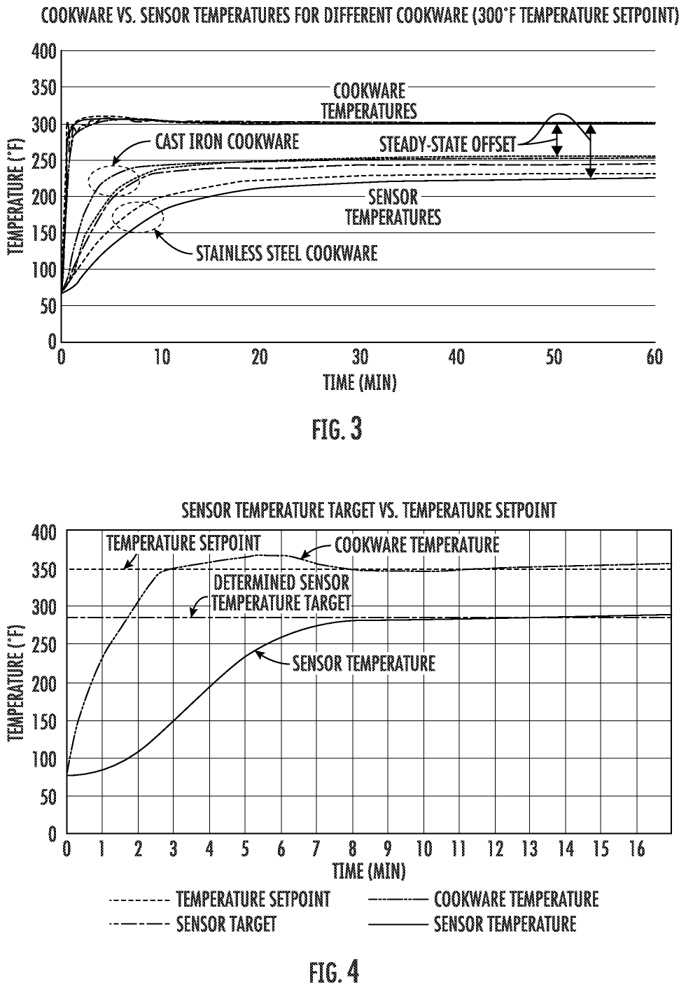

FIGS. 3 through 5 provide graphs illustrating temperature changes of different types of cookware over time and corresponding temperature changes of a temperature sensor (e.g., temperature sensor 40) over time. As mentioned above, temperature sensor 40 may monitor the temperature of cookware item 18 over the course of the cooking or heating operation. As shown particularly in FIGS. 3 and 4, a temperature at cookware item 18 may be offset from a temperature at temperature sensor 40. For instance, when cooktop appliance 12 is an induction style cooktop, cookware item 18 may generate heat and experience higher actual temperatures than temperatures sensed at temperature sensor 40. Thus, an offset may be defined between the observed temperature at temperature sensor 40 and the actual temperature experienced at cookware item 18. Additionally or alternatively, in some embodiments, the offset is opposite. For instance, the temperature at cookware item 18 may be less than the temperature at temperature sensor 40. Accordingly, a steady-state difference or offset between the cookware temperature and the sensor temperature may be positive or negative (e.g., the sensor temperature may stabilize above/greater than or below/less than the cookware item temperature).

Referring to FIG. 4 in particular, for an exemplary cookware item, a temperature setpoint may be determined (or defined, calculated, etc.) at which the cookware item is to be maintained for a cooking or heating operation. Moreover, a temperature sensor target value may be determined. As shown, the temperature sensor target may be offset from the temperature setpoint by a determined amount (e.g., in degrees Fahrenheit). As will be explained below, the offset may vary according to individual cookware items, for instance, based on material composition, size, surface area, thickness, or the like.

The heating operation may include a thermal analysis period or phase (TAP). During the TAP, a thermal behavior of cookware item 18 may be determined (e.g., within controller 50). The TAP may be predetermined within appliance 10 (e.g., during programming or manufacturing) according to empirical testing. For instance, the TAP may be defined between an initiation of the heating operation to between about 2 minutes and about 4 minutes. According to some embodiments, the TAP is between about 1 minute (e.g., 1 minute after the heating operation is initiated) to about 3 minutes (e.g., after the heating operation is initiated). Accordingly, the TAP may be between about 2 minutes and about 4 minutes in total length. During the TAP, temperature sensor 40 may continually send temperature signals to controller 50.

The heating operation may include a cooking phase. The cooking phase may be a feedback controlled cooking phase. In detail, the cooking phase may intelligently adjust one or more parameters according to feedback with respect to cookware item 18, a food being cooked, cooking appliance 10, or the like. Temperature sensor 40 may continually send temperature signals to controller 50 which may then determine, for instance, an error value associated with the feedback controlled cooking phase. The error value may be a difference between a sensor temperature target and an actual observed temperature (e.g., via temperature sensor 40). The error value may be substituted into a feedback equation to determine an adjustment to be made to a control variable. For instance, the control variable may be a power level of heating element 16.

According to at least some embodiments, controller 50 includes a closed-loop feedback control algorithm. The closed-loop feedback control algorithm may be a proportional-integral-derivative (PID) algorithm or equation (e.g., equation or set of equations). In some embodiments, the algorithm may include a proportional algorithm, a proportional-integral algorithm, a proportional-derivative algorithm, or any suitable combination of terms. The PID controller may determine a proportional term (P), an integral term (I), and a derivative term (D). According to at least one embodiment, the PID algorithm is:

$$CV = P + I + D$$

where CV is a controlled variable (e.g., power input to heating element 16), P is the proportional term, I is the integral term, and D is the derivative term. As can be seen, adding each of the P, I, and D terms generates a value for the power level of heating element 16. Each of the P, I, and D terms may be found as follows:

$$P = {K}_{p} * e$$

$$I = {I}_{prev} + {K}_{i} * e * {T}_{s}$$

$$D = {K}_{d} * ( e - {e}_{prev} ) / {T}_{s}$$

where Kₚ is a proportional gain value, Kᵢ is an integral gain value, K_{d} is a derivative gain value, e is an error value (e.g., a difference between a sensor temperature target and an observed temperature), Tₛ is a sampling time or sampling time rate (e.g., a rate at which a discrete system samples inputs), Iₚᵣₑᵥ is a previous integral term (e.g., at the previous sampling event), and eₚᵣₑᵥ is a previous error value (e.g., at the previous sampling event). As noted above, however, in some instances any suitable combination of P, I, and D terms may be incorporated into the algorithm.

Referring now to FIG. 5, a temperature change at temperature sensor 40 over the TAP is illustrated for various cookware items. As shown, temperature sensor 40 may exhibit different temperature changes over the TAP depending on which material is used in the specific cookware item 18. For instance, a cookware item including or composed of cast iron may have a higher temperature rate of change (ROC) than a cookware item including or composed of stainless steel. It should be understood that the cookware items described or mentioned herein are provided by way of example only, and that any suitable or functional cookware item or items may be incorporated into the present disclosure.

As mentioned, temperature sensor 40 may continually monitor a temperature throughout the TAP. At the conclusion of the TAP, the temperature ROC may be calculated. For instance, the ROC may be determined as a change in temperature (e.g., delta T) over a change in time (e.g., delta t). Thus, a difference between the end temperature sensed at temperature sensor 40 (e.g., in degrees Fahrenheit) and the starting or initial temperature at temperature sensor 40 may be divided by the total length of the TAP (e.g., in seconds) to determine the ROC. From the determined ROC, certain properties of the cookware item being used may be inferred, retrieved, assumed, or calculated.

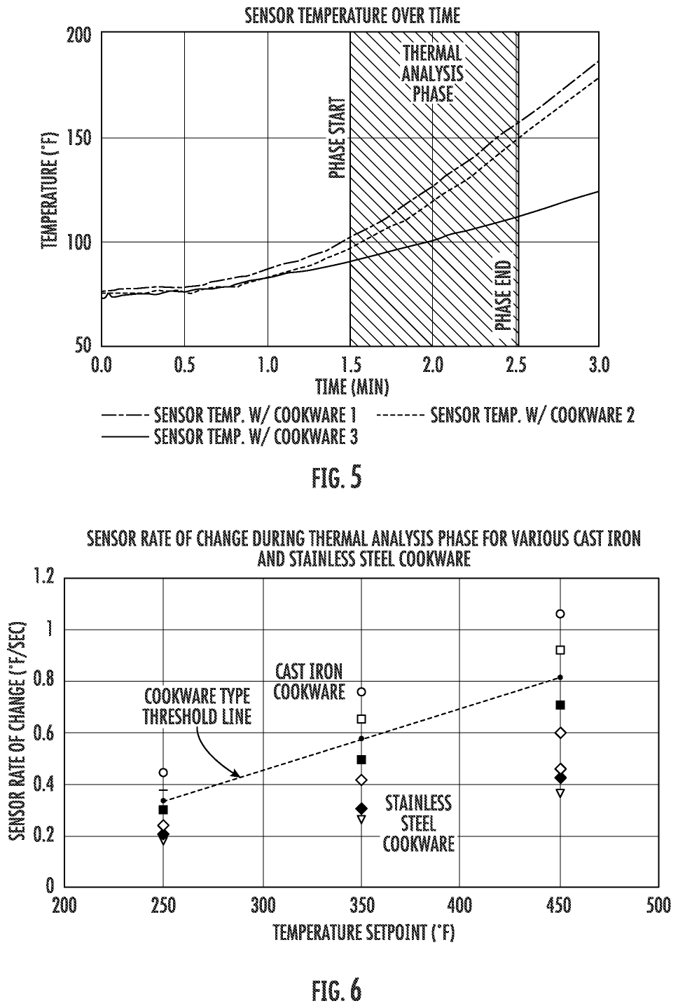

FIG. 6 provides a graph illustrating a temperature ROC for a plurality of cookware items at different temperature setpoints. As will be explained further below, the TAP may be performed at a variety of different temperature setpoints. At each setpoint, the temperature ROC may differ as the heat produced within cookware item 18 may be more intense or less intense. As mentioned above, a cookware item material composition may be inferred from the determined temperature ROC. As shown in FIG. 6, a temperature ROC threshold may be defined. The temperature ROC threshold may be a threshold rate that can be used to differentiate the cookware item material types. For example, cookware items with temperature ROCs above the threshold may be determined to be cast iron cookware items. Additionally or alternatively, cookware items with temperature ROCs below the threshold may be determined to be stainless steel cookware items. Again, it should be understood that additional or alternative cookware item material types may be included or determined.

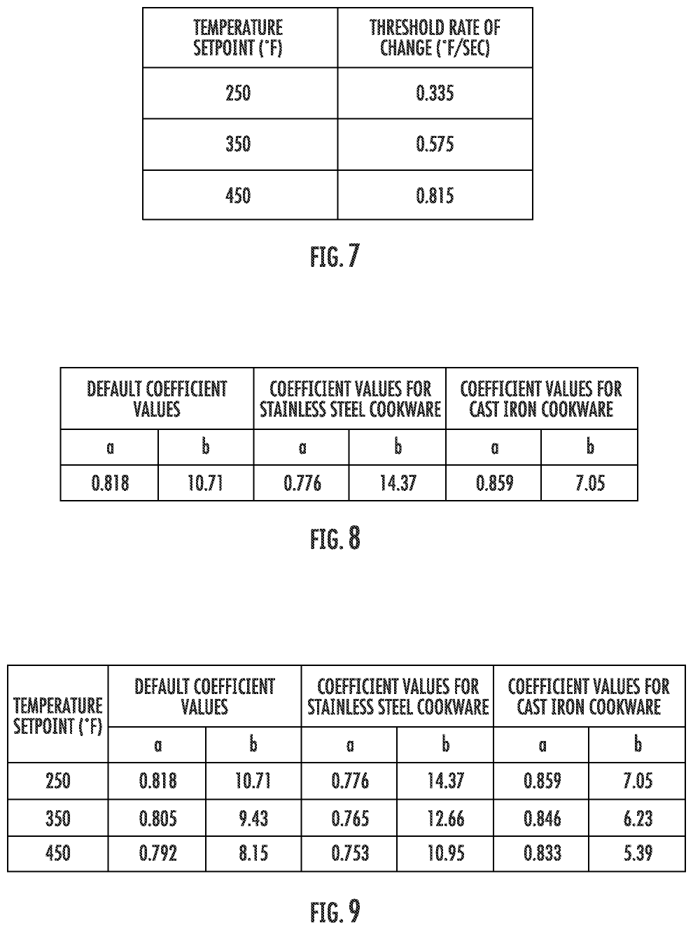

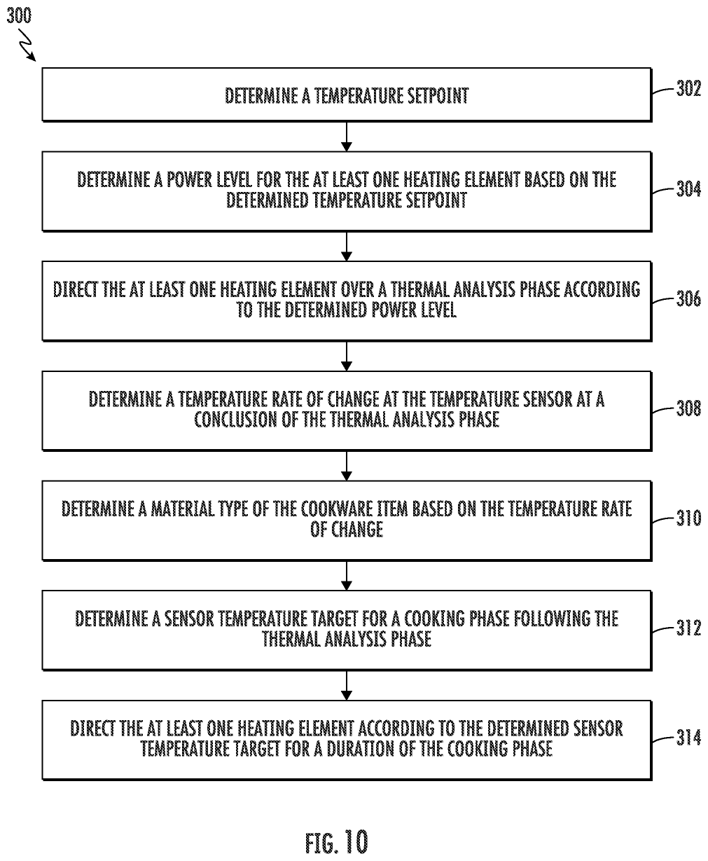

Moreover, variation may be present within each individual cookware item beyond the broad categorization of “above” or “below” the temperature ROC threshold. For instance, certain cast iron cookware items may exhibit slightly higher temperature ROCs than other cast iron cookware items, etc. Thus, the temperature ROC threshold may be determined according to an average of multiple different cookware items including similar material compositions. Additionally or alternatively, a plurality of cookware items of a first material composition (e.g., cast iron) may be tested to determine individual ROCs for each item. Similarly, a plurality of cookware items of a second material composition (e.g., stainless steel) may be tested to determine individual ROCs for each item. The temperature ROC threshold may then be positioned between the closest ROC of the first material item and the closest ROC of the second material item such that each first material item is on one side of the threshold while each second material item is on the opposite side of the threshold. As shown in FIG. 7, for instance, the temperature ROC threshold may be tabulated according to different temperature setpoints. It should be understood that the temperature ROC threshold may be calculated, interpolated, extrapolated, or otherwise determined according to two or more predefined threshold values (e.g., between 250° F. and 350° F.). Accordingly, any suitable temperature setpoint may have a unique temperature ROC threshold value.

As mentioned above, a sensed temperature at temperature sensor 40 may be offset from an actual temperature at cookware item 18. Accordingly, in order to ensure the actual temperature at cookware item 18 is within the desired range, a corresponding steady-state offset may be determined (e.g., retrieved, calculated, etc.). For instance, a sensor temperature target for the closed-loop feedback algorithm may be determined according to the determined material type of cookware item 18 along with the temperature setpoint (e.g., as determined or input by a user). Sensor coefficient values (e.g., a set of sensor coefficient values) may be determined for a particular temperature setpoint to determine the sensor temperature target. For instance, the sensor temperature target may be determined according to the following equation:

$${SP}_{sen} = a * {SP}_{cw} + b$$

where SPₛₑₙ is the sensor temperature target (or sensor setpoint), SP_{cw} is the temperature setpoint (or cookware setpoint) for the cooking or heating operation, and a and b are the sensor coefficient values. The sensor coefficient values may be polynomial coefficients. Additionally or alternatively, the sensor coefficient values may be tabulated (e.g., within a lookup table) to be retrieved by controller 50 for a requested heating operation.

Referring to FIG. 8, for instance, predetermined sets of sensor coefficients may be provided (e.g., within appliance 10). A default set of sensor coefficients (or set of default coefficients) may be incorporated at the outset of the heating operation. For instance, as mentioned above, the heating operation may include a preheating phase, during which cookware item 18 is brought up to the desired temperature (e.g., temperature setpoint). The preheating phase may include the TAP, during which the material composition of the cookware item is determined. Before the material composition is determined, the default set of sensor coefficients may be incorporated into the above equation for estimating the sensor temperature target. Accordingly, an initial sensor temperature target may thus be determined via the set of default sensor coefficients. As further shown in FIG. 8, individual sensor coefficients may be determined and tabulated according to the determined material composition (e.g., cast iron, stainless steel, etc.). Although only two sets of sensor coefficients are shown, it should be understood that additional or alternative coefficients may be predetermined and stored within the table, such as for additional or alternative material types.

In some embodiments, the set of sensor coefficients may further depend on the temperature setpoint. For instance, as shown in FIG. 9, individual sets of sensor coefficients may be determined according to each of the material compositions as well as the temperature setpoint. Accordingly, more defined calculations may be made to determine the sensor temperature target. Additionally or alternatively, coefficient values for different setpoints may be calculated (e.g., interpolated, extrapolated, etc.). For instance, if a temperature setpoint is provided that is not tabulated (e.g., a temperature setpoint between two listed temperature setpoints), equivalent sensor coefficient values may be calculated via one or more calculations.

Now that the construction of cooking appliance 10 and a configuration of controller 50 according to exemplary embodiments have been presented, an exemplary method 300 of operating a cooking appliance will be described. Although the discussion below refers to the exemplary method 300 of operating cooking appliance 10, one skilled in the art will appreciate that the exemplary method 300 is applicable to the operation of a variety of other cooking appliances. In exemplary embodiments, the various method steps as disclosed herein may be performed by controller 50 or a separate, dedicated controller. Additionally or alternatively, the various method steps may be performed in a different order, including additional steps or omitting certain steps according to specific embodiments.

At step 302, method 300 may include determining a temperature setpoint. In detail, a user may communicate with the cooking appliance (e.g., cooking appliance 10) a desire to initiate a cooking operation, a heating operation, or the like. For example, the cooking operation is a feedback controlled heating operation incorporating a PID algorithm to continually monitor the heating operation and perform adjustments as needed. The user may manually enter a temperature setpoint (e.g., a temperature at which the user desires to have the item cooked). Thus, using a user interface (e.g., control panel 22), the user may enter a specific cooking temperature as the temperature setpoint (e.g., 250° F., 300° F., 350° F., etc.). In additional or alternative embodiments, the user may provide information regarding a specific food item to be cooked (e.g., eggs, meat, vegetables, etc.). For instance, the cooking appliance may include features for selecting predetermined food items from the user interface or the cooking appliance may include a remote connectivity (e.g., wireless fidelity [WiFi], Bluetooth®, etc.), through which the user may select a food item (e.g., via a remote device). Further still, the user may input a particular recipe to be cooked on or in the cooking appliance. The temperature setpoint may be stored within the cooking appliance (e.g., within a controller or a memory therein).

At step 304, method 300 may include determining a power level for the at least one heating element based on the determined temperature setpoint. For instance, the cooking operation may include a preheating phase and a cooking phase following the preheating phase. The preheating phase may include the thermal analysis phase (TAP), discussed above, during which the cookware item may be analyzed according to one or more measured parameters (e.g., temperature response). The preheating phase may be instituted as a constant power phase (e.g., not feedback controlled). For instance, a constant power level may be applied to the at least one heating element during the preheating phase. The determined power level may be based at least in part on the temperature setpoint. Thus, a lower temperature setpoint may result in a lower determined power level for the preheating phase, while a higher temperature setpoint may result in a higher determined power level.

At step 306, method 300 may include directing the at least one heating element over the thermal analysis phase (TAP) according to the determined power level. As mentioned, the TAP may be performed during the preheating phase (e.g., during the constant power or non-feedback controlled preheating phase). The TAP may be initiated at the determined power level. For instance, the heating element may be driven at a certain determined power percentage (e.g., 60%, 70%, 80%, etc.) over the TAP. The TAP may be initiated after a predetermined amount of time from the initiation of the heating operation. For instance, the TAP may be initiated between about 1 minute and about 3 minutes after the initiation of the heating operation. Additionally or alternatively, the TAP may be performed for a predetermined length of time. For example, the TAP may be performed for between about 1 minute and about 3 minutes. It should be noted that the time lengths stated herein are provided by way of example only, and that any suitable lengths of time may be incorporated. Over the course of the TAP, a temperature sensed at the temperature sensor (e.g., temperature sensor 40) may be continually monitored, as will be explained.

As mentioned above, an initial sensor temperature target may be determined (e.g., when determining the power level for the at least one heating element for the preheating phase). The initial sensor temperature target may be an approximation based on an initial default temperature offset between the temperature setpoint and the temperature sensor readings, or temperature measured at the temperature sensor. For instance, the default temperature offset may be predetermined or predefined as an average steady-state offset for any or all cookware material types or compositions. Accordingly, the initial sensor temperature target may incorporate a set of default sensor coefficients (e.g., as described above) into an equation to determine the initial sensor temperature target. The at least one heating element may then be directed according to the initial sensor temperature target.

At step 308, method 300 may include determining a temperature rate of change (ROC) at the temperature sensor at the conclusion of the thermal analysis phase. In detail, method 300 may perform one or more calculations to determine a change in the sensed temperature at the temperature sensor over the length of the TAP. In some instances, the temperature at the temperature sensor is continually monitored throughout the TAP. However, additional or alternative embodiments may include recording an initial temperature at the initiation of the TAP and a final temperature at the conclusion, expiration, or end of the TAP. The initial temperature may then be subtracted from the final temperature to obtain the change in temperature, or delta T. The change in temperature may then be divided by the length of the TAP. Accordingly, the temperature ROC may be determined at the conclusion of the TAP.

At step 310, method 300 may include determining a material type (or composition) of the cookware item based on the temperature rate of change (ROC). For instance, as mentioned above, the determined temperature ROC may be compared against a predetermined threshold ROC. Referring again briefly to FIG. 6, the predetermined threshold ROC may be provided for a plurality of temperature setpoints. For instance, the predetermined threshold ROC may be plotted as a line (e.g., as seen in FIG. 6). In comparing the determined temperature ROC against the predetermined threshold ROC, method 300 may determine a material property of the cookware item. For instance, as shown for each particular temperature setpoint, the determined temperature ROC may indicate whether the cookware item is or includes cast iron or stainless steel. According to one example, method 300 determines that the cookware item includes a first material (e.g., cast iron) when the determined temperature ROC is greater than the predetermined threshold ROC, and determines that the cookware item includes a second material (e.g., stainless steel) when the determined temperature ROC is less than the predetermined threshold ROC (e.g., at a particular temperature setpoint). It should be noted that additional or alternative properties or materials may be determined according to the temperature ROC.

At step 312, method 300 may include determining a sensor temperature target for the cooking phase following the thermal analysis phase. As mentioned above, a temperature sensed at the temperature sensor may differ from an actual temperature experienced by the cookware item (e.g., by an offset). Accordingly, in order to maintain the proper temperature at the cookware item, a corresponding sensor temperature target may be determined.

As mentioned above, a set of sensor coefficients may be determined according to the determined material type or composition of the cookware item. The set of sensor coefficients may include a first coefficient (e.g., a) and a second coefficient (e.g., b). Thus, the first sensor coefficient and the second sensor coefficient may be retrieved from a lookup table according to the determined material type of the cookware item. The set of sensor coefficients may then be incorporated into an equation (e.g., as described above) to determine the sensor temperature target.

In additional or alternative embodiments, the set of sensor coefficients may depend on the temperature setpoint as well as the material type of the cookware item. For one example, the cookware item may be determined to include the first material composition, and the temperature setpoint may be a first value (e.g., 300° F.). A particular set of sensor coefficients may thus be retrieved according to the material type and temperature setpoint. Further, as mentioned above, each of the set of sensor coefficients may be calculated based on known values (e.g., for a temperature setpoint between two known temperature setpoints).

At step 314, method 300 may include directing the at least one heating element according to the determined sensor temperature target for a duration of the cooking phase. In detail, upon determining the sensor temperature target, the cooking operation may proceed from the preheating phase (e.g., including the TAP) into the cooking phase. Using the known steady-state temperature offset between the cookware temperature and the sensor temperature (e.g., the sensor temperature target), the cooking operation may be performed as a feedback controlled cooking operation (e.g., incorporating a closed-loop feedback algorithm). The temperature goal (e.g., the temperature at which the closed-loop feedback algorithm maintains) may be the sensor temperature target. Advantageously, a more accurate cooking operation may be performed accounting for the offset between the sensed temperature and the actual temperature of the cookware item.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
at least one heating element to selectively supply heat to a cookware item;
a temperature sensor configured to selectively monitor a temperature of the cookware item; and
a controller operably connected with the at least one heating element and the temperature sensor, the controller configured to perform a heating operation, the heating operation comprising:
determining a temperature setpoint;
determining a power level for the at least one heating element based on the determined temperature setpoint;
directing the at least one heating element over a thermal analysis phase according to the determined power level;
determining a temperature rate of change at the temperature sensor at a conclusion of the thermal analysis phase;
determining a material type of the cookware item based on the temperature rate of change;
determine a sensor temperature target for a cooking phase following the thermal analysis phase, the sensor temperature target being based on the determined material type of the cookware item, and
directing the at least one heating element according to the determined sensor temperature target for a duration of the cooking phase.

2. The cooking appliance of claim 1, wherein directing the at least one heating element over the thermal analysis phase comprises:
determining an initial sensor temperature target via a set of default coefficient values and the determined temperature setpoint; and
directing the at least one heating element according to the initial sensor temperature target.

3. The cooking appliance of claim 1, wherein determining the material type of the cookware item comprises:
comparing the temperature rate of change at the temperature sensor against a predetermined threshold rate of change; and
determining a material composition of the cookware item based on the comparison of the temperature rate of change at the temperature sensor against the predetermined threshold rate of change, wherein the cookware item comprises one of a first material corresponding to the temperature rate of change being greater than the predetermined threshold rate of change or a second material corresponding to the temperature rate of change being less than the predetermined threshold rate of change.

4. The cooking appliance of claim 3, wherein determining the sensor temperature target for the cooking phase comprises:
determining a set of sensor coefficients based on the determined material type of the cookware item, the set of sensor coefficients comprising a first coefficient and a second coefficient.

5. The cooking appliance of claim 4, wherein determining the set of sensor coefficients comprises:
determining a set of first material sensor coefficients corresponding to the first material; and
determining a set of second material sensor coefficients corresponding to the second material, the set of second material sensor coefficients being different from the set of first material sensor coefficients.

6. The cooking appliance of claim 5, wherein determining the set of sensor coefficients further comprises:
determining a first set of first material sensor coefficients corresponding to the first material and a first temperature setpoint; and
determining a second set of first material sensor coefficients corresponding to the first material and a second temperature setpoint, the first temperature setpoint being different from the second temperature setpoint and the first set of first material sensor coefficients being different from the second set of first material sensor coefficients.

7. The cooking appliance of claim 5, wherein determining the set of sensor coefficients further comprises:
determining a first set of second material sensor coefficients corresponding to the second material and a first temperature setpoint; and
determining a second set of second material sensor coefficients corresponding to the second material and a second temperature setpoint, the first temperature setpoint being different from the second temperature setpoint and the first set of second material sensor coefficients being different from the second set of second material sensor coefficients.

8. The cooking appliance of claim 1, wherein the thermal analysis phase is defined between an initiation of the at least one heating element and 3 minutes.

9. The cooking appliance of claim 8, wherein the thermal analysis phase is defined between 1 minute and 2.5 minutes from the initiation of the at least one heating element.

10. A method of operating a cooking appliance, the cooking appliance comprising at least one heating element and a temperature sensor, the method comprising:
determining a temperature setpoint for a cookware item;
determining a power level for the at least one heating element based on the determined temperature setpoint;
directing the at least one heating element over a thermal analysis phase according to the determined power level;
determining a temperature rate of change at the temperature sensor at a conclusion of the thermal analysis phase;
determining a material type of the cookware item based on the temperature rate of change;
determine a sensor temperature target for a cooking phase following the thermal analysis phase, the sensor temperature target being based on the determined material type of the cookware item, and
directing the at least one heating element according to the determined sensor temperature target for a duration of the cooking phase.

11. The method of claim 10, wherein directing the at least one heating element over the thermal analysis phase comprises:
determining an initial sensor temperature target via a set of default coefficient values and the determined temperature setpoint; and
directing the at least one heating element according to the initial sensor temperature target.

12. The method of claim 10, wherein determining the material type of the cookware item comprises:
comparing the temperature rate of change at the temperature sensor against a predetermined threshold rate of change; and
determining a material composition of the cookware item based on the comparison of the temperature rate of change at the temperature sensor against the predetermined threshold rate of change, wherein the cookware item comprises one of a first material corresponding to the temperature rate of change being greater than the predetermined threshold rate of change or a second material corresponding to the temperature rate of change being less than the predetermined threshold rate of change.

13. The method of claim 12, wherein determining the sensor temperature target for the cooking phase comprises:
determining a set of sensor coefficients based on the determined material type of the cookware item, the set of sensor coefficients comprising a first coefficient and a second coefficient.

14. The method of claim 13, wherein determining the set of sensor coefficients comprises:
determining a set of first material sensor coefficients corresponding to the first material; and
determining a set of second material sensor coefficients corresponding to the second material, the set of second material sensor coefficients being different from the set of first material sensor coefficients.

15. The method of claim 14, wherein determining the set of sensor coefficients further comprises:
determining a first set of first material sensor coefficients corresponding to the first material and a first temperature setpoint; and
determining a second set of first material sensor coefficients corresponding to the first material and a second temperature setpoint, the first temperature setpoint being different from the second temperature setpoint and the first set of first material sensor coefficients being different from the second set of first material sensor coefficients.

16. The method of claim 14, wherein determining the set of sensor coefficients further comprises:
determining a first set of second material sensor coefficients corresponding to the second material and a first temperature setpoint; and
determining a second set of second material sensor coefficients corresponding to the second material and a second temperature setpoint, the first temperature setpoint being different from the second temperature setpoint and the first set of second material sensor coefficients being different from the second set of second material sensor coefficients.

17. The method of claim 10, wherein the thermal analysis phase is defined between an initiation of the at least one heating element and 3 minutes.

18. The method of claim 17, wherein the thermal analysis phase is defined between 1 minute and 2.5 minutes from the initiation of the at least one heating element.
